(19) United States
(12) Patent Application Publication
(10) Pub. No.: US 2015/0070524 A1
(43) Pub. Date: Mar. 12, 2015

(54) IMAGE PROCESSING DEVICE

(71) Applicant: Kabushiki Kaisha Toshiba, Tokyo (JP)

(72) Inventors: Tetsuro Tashima, Kanagawa-ken (JP); Yusuke Ikeda, Kanagawa-ken (JP)

(73) Assignee: Kabushiki Kaisha Toshiba, Tokyo (JP)

(21) Appl. No.: 14/192,318

(22) Filed: Feb. 27, 2014

(30) Foreign Application Priority Data
Sep. 9, 2013 (JP) 2013-186016

(51) Int. Cl. H04N 5/235

(52) U.S. Cl. CPC H04N 5/2355
USPC 348/222.1

(57) ABSTRACT

An aspect of one embodiment, there is provided a solid state image-processing device, including a gain adjustment unit configured to adjust each of pixel data transmitted from each of the pixels as gain adjustment data corresponding to a sensitivity ratio between a sensitivity of each of the pixels and a sensitivity of the pixel with the highest sensitivity to transmit each of the pixel data and each of the gain adjustment data, an effectiveness decision unit configured to decide each pixel value being ranged in a prescribed effective range or not, an inversion decision unit configured to decide a pixel with higher sensitivity in two pixels which are an inversion state or not when the pixel data of each of the two pixels are decided to be effective by the effectiveness decision unit, a blend unit configured to blend the gain adjustment data with respect to the two pixel data to transmit blend pixel data when the inversion decision unit is in a non-inversion state, and selection unit configured to select one of the gain adjustment data and the blend pixel data to transmit the selected data as an HDR output data on a basis of a first judge result of the effectiveness decision unit and a second judge result of the inversion decision unit.

### CROSS REFERENCE TO RELATED APPLICATION

This application is based upon and claims the benefit of priority from prior Japanese Patent Application No. 2013-186016, filed on Sep. 9, 2013, the entire contents of which are incorporated herein by reference.

### FIELD

Exemplary embodiments described herein generally relate to an image processing device.

### BACKGROUND

An image processing device using CMOS image sensor as an image processing element has been developed. In the CMOS image sensor, photoelectric conversion is performed, in other words, charges corresponding to inlet photo amount are accumulated and an electric signal with a level corresponding to accumulated charge amount is outputted.

However, the CMOS image sensor generally has a narrower dynamic range corresponding to the inlet photo amount. In a case that a low photo amount area and a high photo amount area are mixed in an image area to be imaged, difficulty is to express all of image areas with a suitable gradation.

Therefore, High Dynamic Range (HDR) processing may be performed to a shot image to enlarge the dynamic range on the inlet photo amount.

One of methods in performing of the HDR processing is described below. A plurality of pixels, each pixel has a different sensitivity, are set in one image area such that each pixel is assigned with a different range of the inlet photo amount. Each pixel having an output signal level ranged in a prescribed level (effective level) is selected.

In such the method, an assigned photo amount area of one pixel is superimposed on those of adjacent two pixels. In such the case, output signals of the two pixels are ranged in an effective level to blend output signal values of the two pixels.

However, the output signal level is saturated with respect to the pixel having sensitivity design described above when a photo amount is inlet over the assigned range of each pixel.

On the other hand, the output signal level may be reversely decreased to generate a reverse phenomenon when a higher photo amount is inlet further over the assigned range of each pixel. In the above phenomenon, charges are overflowed to a region near the pixel.

When the reverse phenomenon is generated, the output signal levels of the two pixels may be ranged in the effective level in the area other than the superimposed area. As a result, an erred HDR processing to blend output signals of the two pixels may be performed.

### BRIEF DESCRIPTION OF THE DRAWINGS

FIG. 1 is a block diagram showing a constitution of an image processing device according to a first embodiment;

FIG. 2 is a graph showing sensitivity characteristics including a high sensitivity pixel, a middle sensitivity pixel and a low sensitivity pixel in the image processing device according to the first embodiment;

FIG. 3 is a graph showing gain adjustment of a gain adjustment unit in the image processing device according to the first embodiment;

FIG. 4 is a graph showing sensitivity characteristic when an inversion is generated in a high sensitivity pixel in the image processing device according to the first embodiment;

FIG. 5 is a graph showing an action of an inversion decision unit in the image processing device according to the first embodiment;

FIG. 6 is a table showing output signals by a selection unit in the image processing device according to the first embodiment;

FIG. 7 is a block diagram showing a constitution of an image processing device according to a second embodiment;

FIG. 8 is a graph showing an action of an extended inversion decision unit in the image processing according to the second embodiment;

FIG. 9 is a table showing output signals by a selection unit in the image processing device according to the second embodiment.

### DETAILED DESCRIPTION

An aspect of one embodiment, there is provided an image processing device, including a plurality of pixel areas, each of the pixel areas comprising a plurality of pixels, each of the pixels mutually having different sensitivity with respect to an input photo amount, the image processing device including, a gain adjustment unit configured to adjust each of pixel data transmitted from each of the pixels as gain adjustment data corresponding to a sensitivity ratio between a sensitivity of each of the pixels and a sensitivity of the pixel with the highest sensitivity to transmit each of the pixel data and each of the gain adjustment data, an effectiveness decision unit configured to decide each pixel value being ranged in a prescribed effective range or not, an inversion decision unit configured to decide a pixel with higher sensitivity in two pixels which are an inversion state or not when the pixel data of each of the two pixels are decided to be effective by the effectiveness decision unit, a blend unit configured to blend the gain adjustment data with respect to the two pixel data to transmit blend pixel data when the inversion decision unit is in a non-inversion state, and selection unit configured to select one of the gain adjustment data and the blend pixel data to transmit the selected data as an HDR output data on a basis of a first judge result of the effectiveness decision unit and a second judge result of the inversion decision unit.

Embodiments will be described below in detail with reference to the attached drawings mentioned above. Throughout the attached drawings, similar or same reference numerals show similar, equivalent or same components, and the description is not repeated. In embodiments, three pixels, each has high sensitivity, middle sensitivity and low sensitivity, respectively, as sensitivity on an inlet photo amount, for example. However, a number of the pixels set in a on a pixel area are not restricted to three pixels.

### First Embodiment

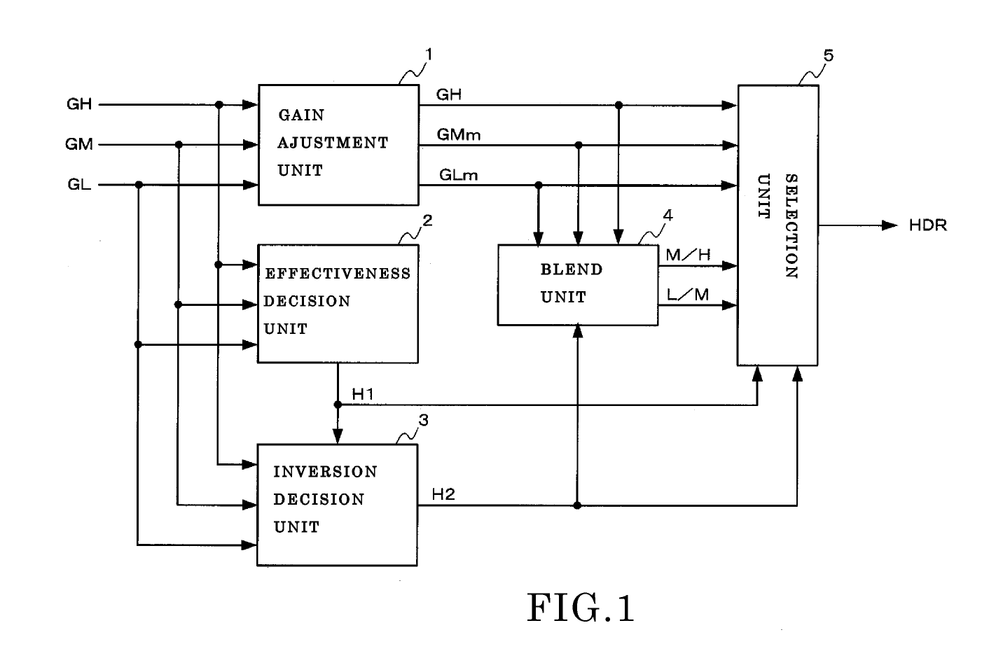

FIG. 1 is a block diagram showing a constitution of an image processing device according to a first embodiment.

In the first embodiment, the image processing device includes gain adjustment unit 1, an effectiveness decision unit 2, an inversion decision unit 3, a blend unit 4 and a selection unit 5. The gain adjustment unit 1 adjusts high sensitivity pixel data GH, middle sensitivity pixel data GM and low sensitivity pixel data GL outputted from a high sensitivity pixel, a middle sensitivity pixel and a low sensitivity pixel, respectively, corresponding to a sensitivity ratio between a sensitivity of each of the pixels and that of the high sensitivity pixel to transmit the high sensitivity pixel data GH, the middle sensitivity pixel data GM, the low sensitivity pixel data GL, and the adjusted data as gain adjustment data. The effectiveness decision unit 2 decides that each of pixel values of the high sensitivity pixel data GH, the middle sensitivity pixel data GM and the low sensitivity pixel data GL is ranged in a prescribed effective range. The inversion decision unit 3 decides that the higher sensitivity pixel of the two pixels is set as an inversion state or not, when both of data of the two pixels are decided to be effective by the effectiveness decision unit 2. The blend unit 4 blends gain adjustment data on the two pixel data, when the inversion decision unit 3 is set as non-inversion state. The selection unit 5 selects one of the gain adjustment data received from the gain adjustment unit 1 and output data of the blend unit 4 to transmit the selected data as HDR output data on a basis of a judge result of the effectiveness decision unit 2 and a judge result of the inversion decision unit 3.

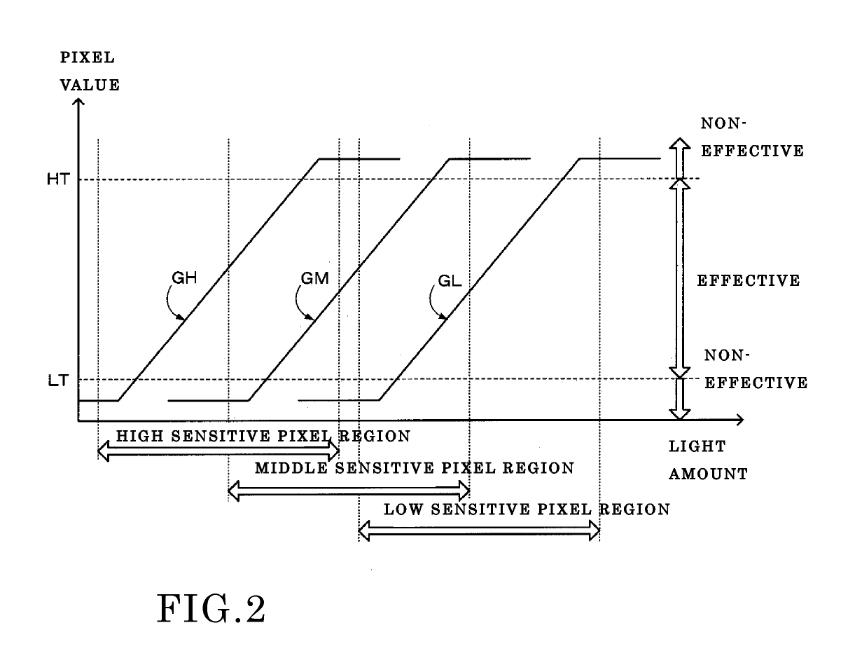

FIG. 2 is a graph showing sensitivity characteristics of a high sensitivity pixel, a middle sensitivity pixel and a low sensitivity pixel on input photo amounts, respectively, in the image processing device.

The high sensitivity pixel, the middle sensitivity pixel and the low sensitivity pixel are assigned to a low photo amount area, a middle photo amount area and a high photo amount area, respectively. On the other hand, a portion of each assigned area of the high sensitivity pixel and the middle sensitivity pixel is superimposed each other, and a portion of each assigned area of the middle sensitivity pixel and the low sensitivity pixel is superimposed each other.

Each of the high sensitivity pixel data GH, the middle sensitivity pixel data GM and the low sensitivity pixel data GL is determined to have a low level threshold value HL and a high level threshold value HT. In each of the high sensitivity pixel data GH, the middle sensitivity pixel data GM and the low sensitivity pixel data GL, the pixel value below the high level threshold value HT and above the low level threshold value HL is effective and a pixel value below the low level threshold value HL and above the high level threshold value HT is non-effective.

The gain adjustment unit 1 adjusts pixel values of the high sensitivity pixel data GH, the middle sensitivity pixel data GM and the low sensitivity pixel data GL, respectively, corresponding to the sensitivity ratio between sensitivity of each pixel and that of the high sensitivity pixel to transmit the adjusted data as gain adjustment data.

The gain adjustment unit 1 directly transmits a high sensitivity pixel data GH as the gain adjustment data with respect to the high sensitivity pixel data GH, as the sensitivity ratio equals to one on the high sensitivity pixel data GH.

The gain adjustment unit 1 transmits a gain adjustment middle sensitivity pixel data GMm and a gain adjustment low sensitivity pixel data GLm as the gain adjustment data on the middle sensitivity pixel data GM and the low sensitivity pixel data GL.

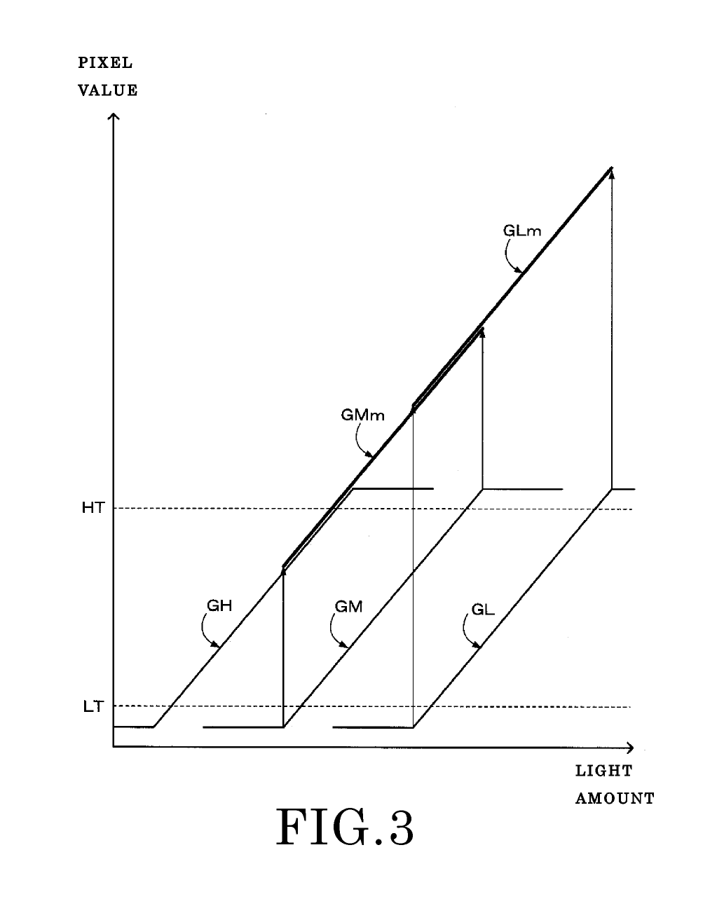

In the above case, the gain adjustment unit 1 adjusts gains with respect to gain adjustment middle sensitivity pixel data GMm and gain adjustment low sensitivity pixel data GLm to nearly fit the middle sensitivity pixel data Gm and the low sensitivity pixel data GL to extrapolating data of the high sensitivity pixel data GH, respectively, as shown in FIG. 3.

The effectiveness decision unit 2 compares each of the pixel values of the high sensitivity pixel data GH, the middle sensitivity pixel data GM and the low sensitivity pixel data GL with the low level threshold value HL and the high level threshold value HT to decide to be effective or not with respect to each of the pixel values.

In the above case, the assigned areas of the high sensitivity pixel and the middle sensitivity pixel, and the assigned areas of the middle sensitivity pixel and the low sensitivity pixel are superimposed. Accordingly, the two pixel data may be concurrently decided to be effective as described above.

In such the case, the blend unit 4 basically blends the gain adjustment data on the two pixel data in an arbitrary blend ratio to transmit blend pixel data in the first embodiment.

Namely, the pixel value of the high sensitivity pixel data GH and the pixel value of the gain adjustment middle sensitivity pixel data GMm are blended to transmit blend pixel data M/H, when the high sensitivity pixel data GH and the middle sensitivity pixel data GM are decided concurrently to be effective. The pixel value of the gain adjustment middle sensitivity pixel data GMm and the pixel value of the gain adjustment low sensitivity pixel data GLm are blended to transmit blend pixel data L/M, when the middle sensitivity pixel data GM and the low sensitivity pixel data GL are decided concurrently to be effective.

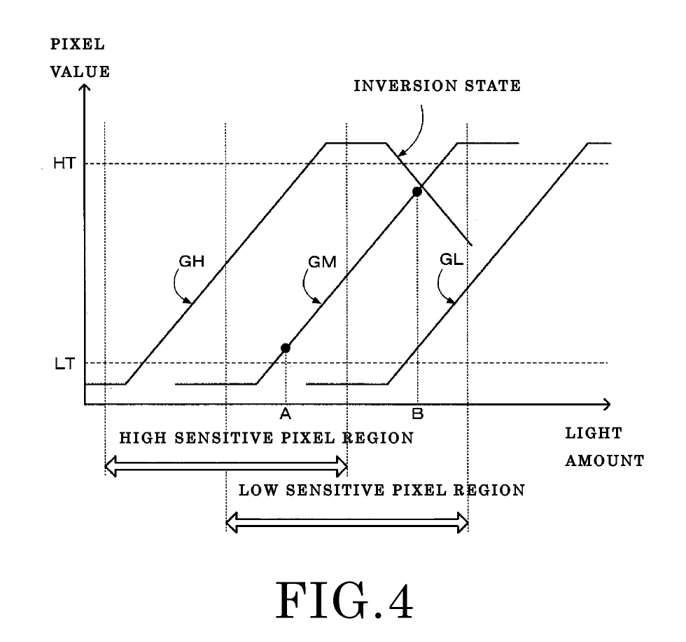

However, when the high sensitivity pixel is inversed, the high sensitivity pixel data GH and the middle sensitivity pixel data GM are decided to be effective on a photo amount B outside the assigned area of the high sensitivity pixel other than a photo amount A in the assigned area of the high sensitivity pixel as shown in FIG. 4.

As the photo amount B is inherently the assigned area of the middle sensitivity pixel, the photo amount B is not necessary to be blended in blend unit 4.

In the first embodiment, when the two pixel data are decided to be effective by the effectiveness decision unit 2, the inversion decision unit 3 decides that the higher sensitivity pixel of the two pixels is in the inversion state or not.

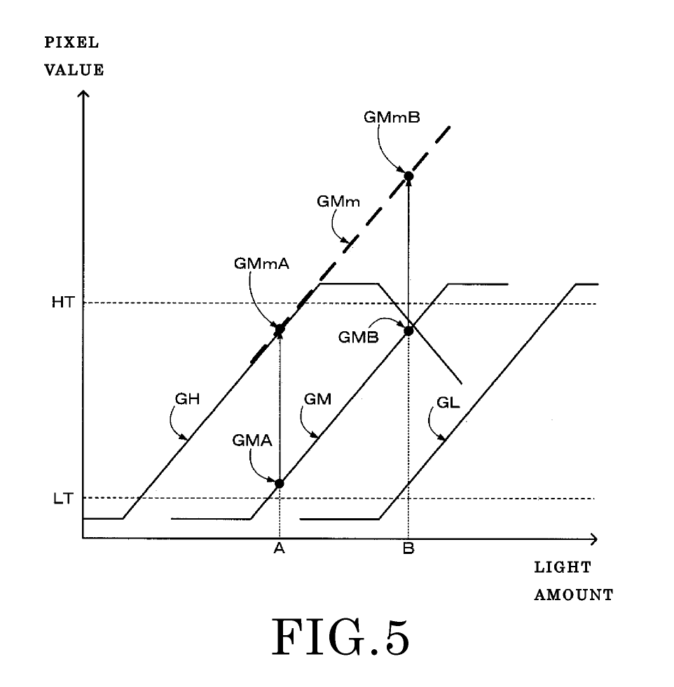

A deciding method by the inversion decision unit 3 is described by using FIG. 5.

When the high sensitivity pixel data GH and the middle sensitivity pixel data GM are decided to be effective, the inversion decision unit 3 obtains the pixel value of the gain adjustment middle sensitivity pixel data GMm to the pixel value of the middle sensitivity pixel data GM.

In an example as shown in FIG. 5, the inversion decision unit 3 obtains a pixel value GMmA of the gain adjustment middle sensitivity pixel data GMm on a pixel value GMA of the middle sensitivity pixel data GM on the photo amount A. Furthermore, inversion decision unit 3 obtains a pixel value GMmB of the gain adjustment middle sensitivity pixel data GMm on a pixel value GMB of the middle sensitivity pixel data GM on the photo amount B.

Next, the inversion decision unit 3 compares the pixel value GMm of the gain adjustment middle sensitivity pixel data GMm with the high level threshold value HT of the high sensitivity pixel data GH.

The inversion decision unit 3 decides that the high sensitivity pixel is set as the non-inversion state in a case of GMm≦HT and decides that the high sensitivity pixel is in the inversion state in a case of GMm>HT.

In an example as shown in FIG. 5, the inversion decision unit 3 decides that the high sensitivity pixel is in the non-inversion state where a comparison result is GMmA≧HT in the case of the photo amount A. Furthermore, the inversion decision unit 3 decides that the high sensitivity pixel is in the inversion state where a comparison result is GMmB>HT in the case of the photo amount B.

The blend unit 4 blends the gain adjustment data with the two pixel data only when the inversion decision unit 3 decides to be in the non-inversion state. Namely, the blend unit 4 blends the pixel value of the high sensitivity pixel data GH and the pixel value of the gain adjustment middle sensitivity pixel data GMm to transmit the blend pixel data M/H.

The selection unit 5 selects one of the high sensitivity pixel data GH, the gain adjustment middle sensitivity pixel data GMm, the gain adjustment low sensitivity pixel data GLm transmitted from the gain adjustment unit 1, and the blend pixel data M/H, L/M transmitted from the blend unit 4 on a basis of a judge result H1 of the effectiveness decision unit 2 and a judge result H2 of the inversion decision unit 3 to transmit the selected data as a HDR output data.

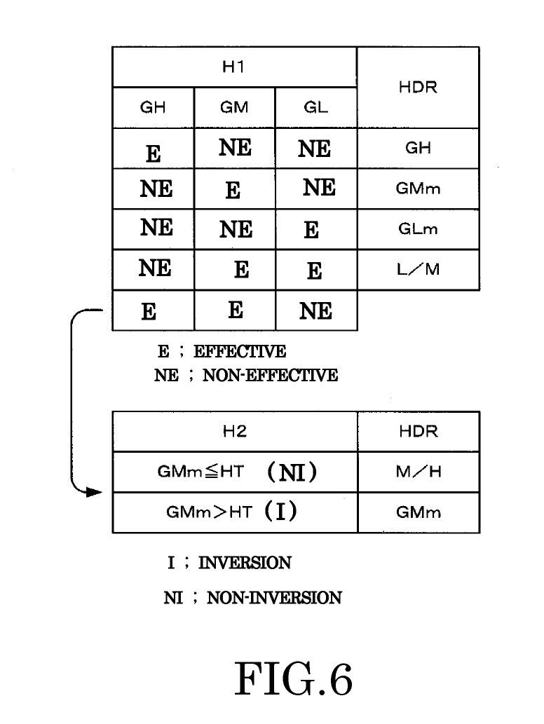

Relationships between the output data of the selection unit 5 and both the judge result H1 of the effectiveness decision unit 2 and the judge result H2 of the inversion decision unit 3 are shown in FIG. 6.

The selection unit 5 selects the high sensitivity pixel data GH in a case that only the high sensitivity pixel data GH is effective, the gain adjustment middle sensitivity pixel data GMm in a case that only the middle sensitivity pixel data GM is effective, the gain adjustment low sensitivity pixel data GLm in a case that the low sensitivity pixel data GL is effective on a basis of the judge result H1. Further, the selection unit 5 selects the blend pixel data L/M in a case that both the middle sensitivity pixel data GM and the low sensitivity pixel data GL are effective.

On the other hand, the selection unit 5 selects data to be transmitted on a basis of the judge result H2 in a case that the judge result H1 shows both the high sensitivity pixel data GH and the middle sensitivity pixel data GM are effective.

In such the situation, the selection unit 5 selects the blend pixel data M/H in a case that the judge result H2 is in the non-inverse state and selects the gain adjustment middle sensitivity pixel data GMm in a case that the judge result H2 is set in the inverse state.

When the judge result H1 of the effectiveness decision unit 2 shows that both the high sensitivity pixel data GH and the middle sensitivity pixel data GM are effective, the inversion decision unit 3 decides that the high sensitivity pixel is in the inversion state or not, so that the pixel data may not blend in a case that the high sensitivity pixel is in the inversion state. In such a manner, a suitable HRD processing can be conducted when the high sensitivity pixel is in the inversion state according to the first embodiment.

### Second Embodiment

In the first embodiment, the image processing device can perform a suitable HDR processing when an inversion phenomenon is generated in the high sensitivity pixel, for example. The inversion phenomenon may be generated in the middle sensitivity pixel and the low sensitivity pixel. Therefore, the image processing device which can perform a suitable HDR processing is described, for example, even when the inversion phenomenon is generated in the middle sensitivity pixel and the low sensitivity pixel in a second embodiment.

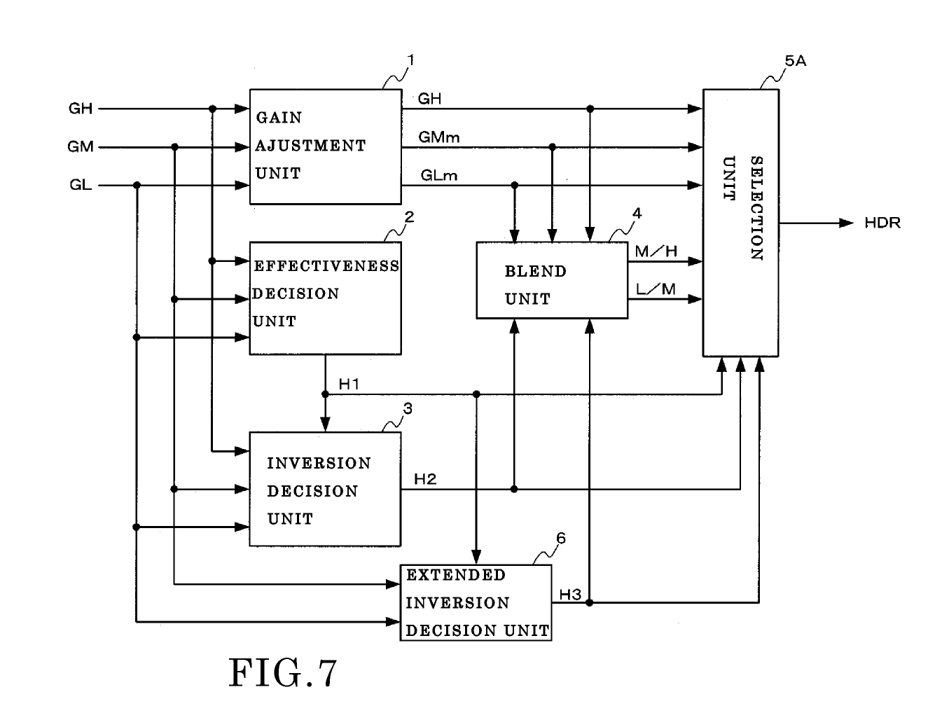

FIG. 7 is a block diagram showing a constitution of an image processing device according to the second embodiment.

The image processing device in the second embodiment adds an extended inversion decision unit 6 and exchanges the selection unit 5 to the selection unit 5A in the constitution of the first embodiment.

The extended inversion decision unit 6 decides two pixels is in the inversion state or not in a case that the low sensitivity pixel data GL is included in the two pixels decided to be effective by the effectiveness decision unit 2.

In the second embodiment, both the middle sensitivity pixel data GM and the low sensitivity pixel data GL is decided to be effective by the effectiveness decision unit 2.

The extended inversion decision unit 6 compares a pixel value GL of the low sensitivity pixel data GL with a pixel value GM of the middle sensitivity pixel data GM to decide both the middle sensitivity pixel and the low sensitivity pixel are in the inversion state in a case that the pixel value GL of the low sensitivity pixel data GL is larger than the pixel value GM of the middle sensitivity pixel data GM.

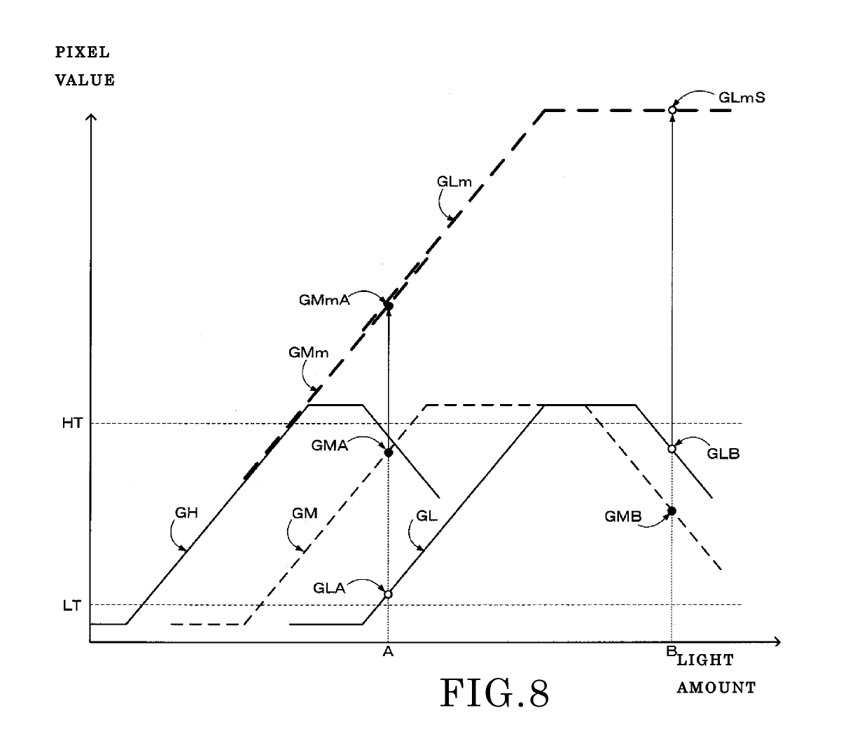

FIG. 8 is a graph showing an action of the extended inversion decision unit in the image processing according to the second embodiment.

As shown in FIG. 8, in a case that the inverse phenomenon is induced in both the middle sensitivity pixel and the low sensitivity pixel are induced, the effectiveness decision unit 2 decides that the middle sensitivity pixel data GM and the low sensitivity pixel data GL is effective in the photo amount A and the photo amount B.

In such the situation, both the middle sensitivity pixel and the low sensitivity pixel are normally operated in the photo amount A, however, the middle sensitivity pixel and the low sensitivity pixel are in the inversion state in photo amount B.

When both the middle sensitivity pixel and the low sensitivity pixel are normally operated, a pixel value GL of the low sensitivity pixel data GL is smaller than the pixel value GM of the middle sensitivity pixel data GM. On the other hand, both the middle sensitivity pixel and the low sensitivity pixel are in the inversion state, the pixel value GL of the low sensitivity pixel data GL is larger than the pixel value GM of the middle sensitivity pixel data GM.

The extended inversion decision unit 6 compares the pixel value GL of the low sensitivity pixel data GL with the pixel value GM of the middle sensitivity pixel data GM to decide both the middle sensitivity pixel and the low sensitivity pixel are in the inversion state, in a case that the pixel value GL of the low sensitivity pixel data GL is larger than the middle sensitivity pixel data GM.

In FIG. 8 as the example, a pixel value GLA of the low sensitivity pixel data GL is smaller than a pixel value GMA of the middle sensitivity pixel data GM in the photo amount A. Accordingly, the extended inversion decision unit 6 decides that both the middle sensitivity pixel and the low sensitivity pixel are in the non-inversion state. On the other hand, the pixel value GLA of the low sensitivity pixel data GL is larger than the pixel value GMA of the middle sensitivity pixel data GM in the photo amount B. Accordingly, the extended inversion decision unit 6 decides that both the middle sensitivity pixel and the low sensitivity pixel are in the inversion state.

The selection unit 5A adds a judge result H3 of the extended inversion decision unit 6 to the judge result H1 of the effectiveness decision unit 2 and the judge result H2 of the inversion decision unit 3 to select the data to be outputted.

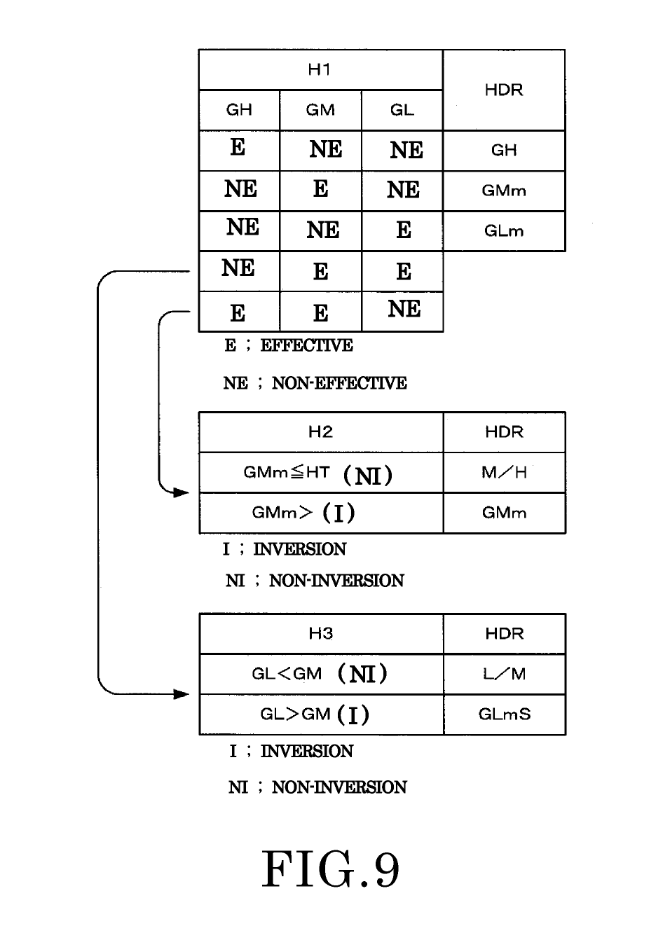

Relationships between the output data HDR of the selection unit 5 and the judge result H1 of the effectiveness decision unit 2, the judge result H2 of the inversion decision unit 3 and the judge result H3 of the extended inversion decision unit 6 are shown in a table of FIG. 9 according to the second embodiment.

The selection unit 5A selects the high sensitivity pixel data GH in a case that only the high sensitivity pixel data GH is effective, the gain adjustment middle sensitivity pixel data GMm in a case that only the middle sensitivity pixel data GM is effective, and the gain adjustment low sensitivity pixel data GLm in a case that only the low sensitivity pixel data GL is effective on a basis of the judge result H1.

On the other hand, the selection unit 5A selects the data to be outputted on a basis of the judge result H2 in a case that the judge result H1 shows both the high sensitivity pixel data GH and the middle sensitivity pixel data GM are effective.

In such the situation, the selection unit 5A selects the blend pixel data M/H in a case that the judge result H2 is in the non-inversion state and selects the gain adjustment middle sensitivity pixel data GMm in a case that the judge result H2 is in the inversion state.

The selection unit 5A selects the output data to be outputted on a basis of the judge result H3 in a case that the judge result H1 shows the middle sensitivity pixel data GM and the low sensitivity pixel data GL being effective.

In the above case, the selection unit 5A selects the blend pixel data L/M in a case that the judge result H3 is in the non-inversion and selects the gain adjustment low sensitivity pixel data GLm in a case that the judge result H3 is in the inversion. In such the case, pixel value of the gain adjustment low sensitivity pixel data GLm reach a saturation value GLmS.

In a case that the judge result H1 of the effectiveness decision unit 2 shows both the middle sensitivity pixel data GM and the low sensitivity pixel data GL being effective, the extended inversion decision unit 6 decides that the middle sensitivity pixel and the low sensitivity pixel are in the inversion state or not in the second embodiment. As a result, the blend of the pixel data cannot be performed when the middle sensitivity pixel and the low sensitivity pixel are in the inversion state. In such a manner, suitable HDR processing is performed when the middle sensitivity pixel and the low sensitivity pixel are in the inversion state.

As described above, the suitable HDR processing can be performed when the inversion phenomenon is generated in the output signal of the pixel in the image processing device according at least one embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device, the image processing device comprising a plurality of pixel areas, each of the pixel areas comprising a plurality of pixels, each of the pixels mutually having different sensitivity with respect to an input photo amount, the image processing device comprising:
a gain adjustment unit configured to adjust each of pixel data transmitted from each of the pixels as gain adjustment data corresponding to a sensitivity ratio between a sensitivity of each of the pixels and a sensitivity of the pixel with the highest sensitivity to transmit each of the pixel data and each of the gain adjustment data;
an effectiveness decision unit configured to decide each pixel value being ranged in a prescribed effective range or not;
an inversion decision unit configured to decide a pixel with higher sensitivity in two pixels which are an inversion state or not when the pixel data of each of the two pixels are decided to be effective by the effectiveness decision unit;
a blend unit configured to blend the gain adjustment data with respect to the two pixel data to transmit blend pixel data when the inversion decision unit is in a non-inversion state; and
a selection unit configured to select one of the gain adjustment data and the blend pixel data to transmit the selected data as an HDR output data on a basis of a first judge result of the effectiveness decision unit and a second judge result of the inversion decision unit.

2. The image processing device of claim 1, wherein
a pixel area of each of the pixels is superimposed with a pixel area of another pixel.

3. The image processing device of claim 1, wherein
the gain adjustment data on the two pixel data is blended due to arbitrary blend ratio.

4. The image processing device of claim 1, wherein
the inversion decision unit adjusts the pixel data of the pixel with lower sensitivity by the sensitivity ratio of the pixel data of the pixel with higher sensitivity with respect to the pixel data with lower sensitivity, compares the gain adjustment data with a high level threshold value in an effective range of the pixel data of the pixel with higher sensitivity to decide that the pixel with higher sensitivity is in the inversion state in a case that the gain adjustment data is larger than the high level threshold value, and the pixel with higher sensitivity is in the non-inversion state in a case that the gain adjustment data is lower than the high level threshold value.

5. The image processing device of claim 1, wherein
the selection unit selects the gain adjustment data with respect to the pixel data of one pixel in the two pixel in a case that the effectiveness decision unit decides the pixel data of the one pixel of the two pixels being effective,
the selection unit selects the blend pixel data in a case that the effectiveness decision unit decides the two pixel data being effective and the inversion decision unit decides the two pixel data being in the non-inversion state, and
the selection unit selects the gain adjustment data with respect to the pixel data of the pixel with lower sensitivity in a case that the effectiveness decision unit decides the two pixel data being effective and the inversion decision unit decides the two pixel data being in the inversion state.

6. The image processing device of claim 1, wherein
the gain adjustment unit adjust that the gain adjustment data fit to extrapolating data of the pixel data of the highest sensitivity pixel.

7. The image processing device of claim 1, further comprising:
an extended inversion decision unit configured to decide the two pixels being in the inversion state when the pixel data of the pixel with the lowest sensitivity is included in the two pixel data which are decided to be effective by the effectiveness decision unit,
wherein the extended inversion decision unit compares the pixel value of the pixel data of the pixel with the lowest sensitivity in the two pixels and the other pixel value of the pixel data to decide the two pixels being the inversion state when the pixel value of the pixel data of the pixel with the lowest sensitivity is larger than the other pixel value of the pixel data.

8. The image processing device of claim 7, wherein
the selection unit transmits a saturation value of the gain adjustment data with respect to the pixel data of the pixel with the lowest sensitivity when the extend inversion decision unit decides the data of the two pixels being in the inversion state.
